(19) United States
(12) Patent Application Publication
(10) Pub. No.: US 2008/0200596 A1
(43) Pub. Date: Aug. 21, 2008

(54) Crystalline thermoplastic polymer composition

(75) Inventors: Yusuke Kawamura, Niihama-shi (JP); Yoshiaki Oobayashi, Kamakura-shi (JP); Katsuhisa Kitano, Ichihara-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/004,521

(22) Filed: Dec. 21, 2007

(30) Foreign Application Priority Data
Dec. 26, 2006 (JP) 2006-349249

(51) Int. Cl. C08K 5/09; C08K 3/10

(52) U.S. Cl. 524/287; 524/437

(57) ABSTRACT

The object of the present invention is to provide a crystalline thermoplastic polymer composition which exhibits higher stiffness.

The present invention relates to a crystalline thermoplastic polymer composition comprising a crystalline thermoplastic polymer and a crystal nucleating agent coated aluminum hydroxide, the amount of the crystal nucleating agent coated aluminum hydroxide being from 1 to 20 parts by mass based on 100 parts by mass of the crystalline thermoplastic polymer, the crystal nucleating agent coated aluminum hydroxide comprising anisotropic shaped aluminum hydroxide particles and a crystal nucleating agent coated on the surface of the anisotropic shaped aluminum hydroxide particles, the crystal nucleating agent coated aluminum hydroxide having a BET specific surface area of 20 to 150 m²/g.

### BACKGROUND OF THE INVENTION

1. Field of the Invention

The present invention relates to a crystalline thermoplastic polymer composition.

2. Description of the Related Art

A crystalline thermoplastic polymer composition comprising a crystalline thermoplastic polymer typified by polyethylene, polypropylene and poly-1-butene and a crystal nucleating agent is widely used as a molding material because fine crystals of the crystalline thermoplastic polymer are easily produced in the case of being solidified with cooling from the heat-melted state. Furthermore, Patent Document 1 (Japanese Unexamined Patent Publication (Kokai) No. 6-220258) discloses, as a crystalline thermoplastic polymer composition which exhibits higher stiffness, a crystalline thermoplastic polymer composition comprising an organic acid as a crystal nucleating agent and a needle shaped aluminum hydroxide.

Such a crystalline thermoplastic polymer composition requires a crystalline thermoplastic polymer composition which exhibits higher stiffness.

### Patent Document 1: Japanese Unexamined Patent Publication (Kokai) No. 6-220258

### Patent Document 2: Japanese Unexamined Patent Publication (Kokai) No. 2000-239014

### Patent Document 3: Japanese Unexamined Patent Publication (Kokai) No. 2006-160541

### Patent Document 4: Japanese Unexamined Patent Publication (Kokai) No. 2006-83251

### Patent Document 5: Japanese Unexamined Patent Publication (Kokai) No. 4-323207

### Patent Document 6: Japanese Unexamined Patent Publication (Kokai) No. 61-287917

Non-Patent Document 1: “Introduction of Polymer Chemistry (Kobunshi-Kagaku Joron), written by Seizo OKAMOTO et al., Kagaku-Dojin Publishing Company, Inc. (published in 1970) Non-Patent Document 2: “New Edition of Polymer Analysis Handbook (Shinpan Kobunshi-Bunseki Handobukku), edited by The Japan Society for Analytical Chemistry/Study Meeting on Polymer Analysis, KINOKUNIYA COMPANY LTD. (published in 1995)

### SUMMARY OF THE INVENTION

The present inventors have intensively studied so as to develop a crystalline thermoplastic polymer composition which exhibits higher stiffness, and thus the present invention has been completed.

The present invention provides a crystalline thermoplastic polymer composition comprising a crystalline thermoplastic polymer and a crystal nucleating agent coated aluminum hydroxide described below, the amount of the crystal nucleating agent coated aluminum hydroxide being from 1 to 20 parts by mass based on 100 parts by mass of the crystalline thermoplastic polymer.

Crystal nucleating agent coated aluminum hydroxide: comprises a crystal nucleating agent coated on the surface of the anisotropic shaped aluminum hydroxide particles, and has a BET specific surface area of 20 to 150 m²/g.

The crystalline thermoplastic polymer composition of the present invention exhibits high stiffness.

### DETAILED DESCRIPTION OF THE INVENTION

A main crystal phase of the anisotropic shaped aluminum hydroxide used in the present invention is usually boehmite. The crystal phase of the anisotropic shaped aluminum hydroxide can be identified by an X-ray diffraction method.

The anisotropic shaped aluminum hydroxide usually has an agglomerate particle diameter measured by a laser diffraction method within a range from about 0.1 to 10 μm. As used herein, the laser diffraction method means a method of calculating a particle diameter of particles utilizing the fact that the intensity of light scattered and a pattern vary with each particle diameter when the particles are irradiated with light. The agglomerate particle diameter is measured as a particle diameter in which an accumulated weight corresponds to 50% by weight in a particle diameter distribution curve of accumulated weight versus particle diameter (50 wt % equivalent particle diameter: D₅₀).

The anisotropic shaped aluminum hydroxide particles have a shape in which lengths in two or more directions among three perpendicularly intersecting directions, and include needle, plate, tube, spindle and oval shaped aluminum hydroxide particles. Of these anisotropic shaped aluminum hydroxide particles, those having an aspect ratio of 3 or more are preferably used. The aspect ratio is expressed as the ratio (a/b) of a length (a) in a direction where the length is the longest (a-axis) to the length (b) in a direction where the length is the shortest (b-axis) among the three perpendicularly intersecting directions of the anisotropic shaped aluminum hydroxide particles. Of the anisotropic shaped aluminum hydroxide particles having an aspect ratio (a/b) of 3 or more, needle shaped aluminum hydroxide particles are more preferable.

The major axis of the needle shaped aluminum hydroxide particles is usually from 0.3 to 10 μm, and preferably from 0.5 to 5 μm, the minor axis is usually from 0.005 to 0.5 μm, and preferably from 0.05 to 0.2 μm, and the aspect ratio is usually from 5 to 50, preferably from 5 to 30, and more preferably from 10 to 30, in view of good dispersibility in the crystalline thermoplastic polymer. The major axis and the minor axis of the needle shaped aluminum hydroxide particles can be measured by visual observation using an electron microscope. The major axis is measured as a length in the direction where the length is the longest using an electron microscope, while the minor axis is measured as the length in the direction perpendicular to the direction where the length is the longest.

The method for measuring the major axis and the minor axis using an electron microscope will now be described. First, a needle shaped aluminum hydroxide particles in the form a slurry or a dry powder are diluted with a solvent to prepare a solution having a solid content of 1% or less. The resulting solution is dropped on a specimen support in a state where aggregate particles are dispersed by a method such as stirring or ultrasonic irradiation, and then dried. As the solvent used for dilution, for example, it is possible to appropriately select solvents such as water and alcohol in which the needle shaped aluminum hydroxide particles are easily dispersed. An electron micrograph of the dried needle shaped aluminum hydroxide particles is taken. The needle shaped aluminum hydroxide particles, which are laid one upon another, are appropriately selected from the resulting electron micrograph, and then the major axis and the minor axis are measured.

The aspect ratio of the needle shaped aluminum hydroxide particles is calculated as the ratio of the major axis to the minor axis (major axis/minor axis) measured from the electron micrograph.

The method for producing the needle shaped aluminum hydroxide includes, for example, a method described in Patent Document 2 (Japanese Unexamined Patent Publication (Kokai) No. 2000-239014) in which an aluminum hydroxide was hydrothermally treated in the presence of a metal acetate, and a method of conducting a hydrothermal treatment of a boehmite-type aluminum hydroxide and a gibbsite-type aluminum hydroxide described in Patent Document 3 (Japanese Unexamined Patent Publication (Kokai) No. 2006-160541) in the presence of magnesium. The needle shaped aluminum hydroxide can also be produced by acidifying an aqueous solution containing an aluminum hydroxide and a metal acetate added therein with carboxylic acid, followed by a hydrothermal treatment.

On the surface of anisotropic shaped aluminum hydroxide particles, a crystal nucleating agent is coated. The crystal nucleating agent includes, for example, an aromatic carboxylic acid compound represented by formula (I):

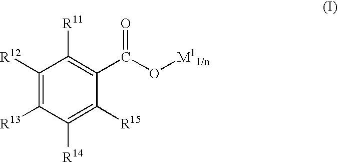

wherein R¹¹, R¹², R¹³, R¹⁴ and R¹⁵ each independently represents a hydrogen atom, an alkyl group having 1 to 4 carbon atoms, or a carboxyl group; M¹ represents a hydrogen atom or a mono- to trivalent metal atom; and n represents a valence of the hydrogen atom or the metal atom represented as M¹, or the formula (II):

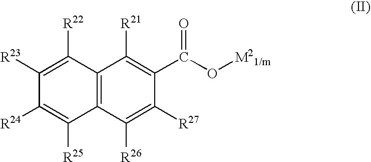

wherein R²¹, R²², R²³, R²⁴, R²⁵, R²⁶ and R²⁷ each independently represents a hydrogen atom, an alkyl group having 1 to 4 carbon atoms, or a carboxyl group; M² represents a hydrogen atom or a mono- to trivalent metal atom; and m represents the valence of the hydrogen atom or the metal atom represented as M², an aromatic organophosphate, a metal salt of an ethylene-methacrylic acid copolymer, a dibenzylidenesorbitol derivative and a rosin acid partial metal salt, of which an aromatic carboxylic acid compound represented by the formula (I) and an aromatic carboxylic acid compound represented by the formula (II) are preferable.

Specific examples of the aromatic carboxylic acid compound represented by the formula (I) include benzoic acid, p-methylbenzoic acid, o-methylbenzoic acid, m-methylbenzoic acid, p-ethylbenzoic acid, p-tert-butylbenzoic acid, m-tert-butylbenzoic acid, and a sodium salt, a lithium salt, a zinc salt, a magnesium salt and an aluminum salt thereof. Specific examples of the aromatic carboxylic acid compound represented by the formula (II) include 1-naphthoic acid, 2-naphthoic acid, 4-methyl-1-naphthoic acid, and a sodium salt, a lithium salt, a zinc salt, a magnesium salt and an aluminum salt thereof. The crystal nucleating agent is more preferably benzoic acid, sodium benzoate, 1-naphthoic acid or 2-naphthoic acid.

The coated amount of the crystal nucleating agent is usually 0.1 parts by mass or more based on 100 parts by mass of the anisotropic shaped aluminum hydroxide particles in view of the fact that the stiffness can be easily increased, and is usually 100 parts by mass or less, and preferably 50 parts by mass or less, in view of the fact that the effect corresponding to the coated amount is easily obtained.

The BET specific surface area of the crystal nucleating agent coated aluminum hydroxide is from 20 to 150 m²/g, and 100 m²/g or less. When the BET specific surface area is less than 20 m²/g, the stiffness is not sufficiently improved. In contrast, when the BET specific surface area is more than 150 m²/g, particles are likely to be aggregated and it becomes difficult to be uniformly dispersed in the crystalline thermoplastic polymer.

The method for producing such a crystal nucleating agent coated aluminum hydroxide includes, for example:

(1) a wet coating method in which a crystal nucleating agent is dissolved or dispersed in a solvent and anisotropic shaped aluminum hydroxide particles are dispersed, and then the solvent is distilled off, and
(2) a dry coating method in which anisotropic shaped aluminum hydroxide particles and a crystal nucleating agent are mixed and stirred without using a solvent, of which a wet coating method is preferable in view of the fact that anisotropic shaped aluminum hydroxide particles are not broken during stirring.

It is possible to use, as the solvent used in the wet coating method, those capable of easily dissolving or dispersing a crystal nucleating agent and easily dispersing anisotropic shaped aluminum hydroxide particles. Specific examples thereof include polar solvents such as water and alcohol; and nonpolar solvents such as toluene and benzene. When water is used as the solvent, the hydrogen ion concentration is preferably less than pH 7.

In order to dissolve or disperse anisotropic shaped aluminum hydroxide particles and a crystal nucleating agent in the solvent, for example, the anisotropic shaped aluminum hydroxide particles and the crystal nucleating agent may be added to the solvent, followed by stirring or irradiation with ultrasonic wave.

The method of distilling off the solvent includes, for example, a method of distilling off the solvent by heating a mixture prepared by dispersing anisotropic shaped aluminum hydroxide particles and dissolving or dispersing a crystal nucleating agent in the solvent, and a method of distilling off the solvent under reduced pressure. Also, the solvent may be distilled off by a drying method such as a freeze-drying method, a flash-drying method or a spray-drying method.

Such a crystal nucleating agent coated aluminum hydroxide is used by being mixed with a crystalline thermoplastic polymer composition.

The amount of the crystal nucleating agent coated aluminum hydroxide in the crystalline thermoplastic polymer composition of the present invention is usually 1 part by mass or more based on 100 parts by mass of the anisotropic shaped aluminum hydroxide particles in view of an improvement in the crystallization temperature, and is usually 20 parts by mass or less, and preferably 10 parts by mass or less, in view of the fact that the effect corresponding to the coated amount is easily obtained.

The crystalline thermoplastic polymer used in the present invention is usually a thermoplastic polymer having crystallinity of 10% or more, and preferably 20% or more. The crystallinity can be measured by a method such as an X-ray method, a density method, an infrared absorption method, an NMR method or a thermal method, as described in Non-Patent Document 1 (“Introduction of Polymer Chemistry (Kobunshi-Kagaku Joron), written by Seizo OKAMOTO et al., Kagaku-Dojin Publishing Company, Inc. (published in 1970)) and Non-Patent Document 2 (“New Edition of Polymer Analysis Handbook (Shinpan Kobunshi-Bunseki Handobukku), edited by The Japan Society for Analytical Chemistry/Study Meeting on Polymer Analysis, KINOKUNIYA COMPANY LTD. (published in 1995)).

Examples of the crystalline thermoplastic polymer used in the present invention include an olefin polymer; a modified olefin polymer; an aromatic polyester such as polyethylene terephthalate or polybutylene terephthalate; a polyester such as polycaprolactone; a polyamide such as an aliphatic polyamide (nylon-6, nylon-66 or nylon-12) or an aromatic polyamide produced from an aromatic dicarboxylic acid and an aliphatic diamine; and a polyacetal such as polyformaldehyde (polyoxymethylene), polyacetaldehyde, polypropylene aldehyde or polybutyl aldehyde. These thermoplastic polymers are used alone, or two or more kinds of them are used in combination. Of these thermoplastic polymers, an olefin polymer is preferably used.

The olefin polymer is a polymer containing an olefin unit as a main monomer component. The olefin polymer includes, for example, an α-olefin polymer containing polyethylene, polypropylene and α-olefin having 4 or more carbon atoms as main monomer components.

The polyethylene is a polymer containing an ethylene unit as a main monomer component and is specifically a polymer containing 50 mol % or more of an ethylene unit, and examples thereof include an ethylene homopolymer composed of an ethylene unit alone, a random copolymer of ethylene and another monomer copolymerizable with ethylene, and a block copolymer of ethylene and another monomer copolymerizable with ethylene. Examples of the other monomer copolymerizable with ethylene include an α-olefin having 3 to 20 carbon atoms such as propylene, 1-butene, 1-pentene, 1-hexene, 1-octene or 1-decene; an acrylate ester such as methyl acrylate; and vinyl acetate.

Specific examples of the random copolymer of ethylene and another monomer copolymerizable with ethylene include an ethylene-α-olefin random copolymer such as an ethylene-propylene random copolymer, an ethylene-1-butene random copolymer, an ethylene-1-pentene random copolymer, an ethylene-1-hexene random copolymer, an ethylene-1-octene random copolymer, or an ethylene-1-decene random copolymer; an ethylene-acrylate ester random copolymer; and an ethylene-vinyl acetate random copolymer.

Specific examples of the block copolymer of ethylene and another monomer copolymerizable with ethylene include an ethylene-α-olefin block copolymer such as an ethylene-propylene block copolymer, an ethylene-1-butene block copolymer, an ethylene-1-pentene block copolymer, an ethylene-1-hexene block copolymer, an ethylene-1-octene block copolymer, or an ethylene-1-decene block copolymer; an ethylene-acrylate ester block copolymer; and an ethylene-vinyl acetate block copolymer.

The polypropylene is a polymer containing a propylene unit as a main monomer component and is specifically a polymer containing 50 mol % or more of propylene, and examples thereof include a propylene homopolymer composed of a propylene unit alone, a random copolymer of propylene and another monomer copolymerizable with propylene, and a propylene block copolymer obtained by, after homopolymerizing propylene, copolymerizing propylene with another monomer copolymerizable with propylene. Examples of the other monomer copolymerizable with propylene include an α-olefin having 4 to 20 carbon atoms such as ethylene, 1-butene, 1-pentene, 1-hexene, 1-octene or 1-decene; and the same acrylate esters and vinyl acetate as those described above. The polypropylene is preferably a propylene homopolymer or a propylene block copolymer in view of heat resistance, and more preferably a propylene homopolymer in view of stiffness.

Examples of the random copolymer of propylene and the other monomer copolymerizable with propylene include a propylene-ethylene random copolymer, a propylene-1-butene random copolymer, a propylene-ethylene-1-butene random copolymer, a propylene-acrylate ester random copolymer and a propylene-vinyl acetate random copolymer.

Examples of the propylene block copolymer obtained by, after homopolymerizing propylene, copolymerizing propylene with another monomer copolymerizable with propylene include a propylene-ethylene block copolymer obtained by, after homopolymerizing propylene, copolymerizing ethylene with propylene; a propylene-butene block copolymer obtained by, after homopolymerizing propylene, copolymerizing propylene with butene; a propylene-1-pentene block copolymer obtained by, after homopolymerizing propylene, copolymerizing 1-pentene with propylene; and a propylene-1-hexene block copolymer obtained by, after homopolymerizing propylene, copolymerizing 1-hexene with propylene.

The α-olefin polymer containing an α-olefin having 4 or more carbon atoms as a main monomer component is a polymer containing 50 mol % or more of an α-olefin having 4 or more carbon atoms, and examples thereof include a 1-butene homopolymer composed of an α-olefin unit having 4 or more carbon atoms alone, and a copolymer of an α-olefin having 4 or more carbon atoms and another monomer copolymerizable with the α-olefin having 4 or more carbon atoms.

Examples of the method for producing an olefin polymer include a solution polymerization method, a slurry polymerization method, a bulk polymerization method and a vapor phase polymerization method. The method also includes polymerization methods described in Non-Patent Document 3 (“New Process for Production of Polymer”, edited by Yasuharu SAEKI, Kogyo Chosakai Publishing, Inc. (published in 1994)), Patent Document 5 (Japanese Unexamined Patent Publication (Kokai) No. 4-323207) and Patent Document 6 (Japanese Unexamined Patent Publication (Kokai) No. 61-287917).

Examples of the catalyst used in the production of an olefin polymer include a multi-site catalyst and a single-site catalyst. The multi-site catalyst is preferably a catalyst obtained by using a solid catalyst component containing a titanium atom, a magnesium atom and a halogen atom. The single-site catalyst is preferably a metallocene complex.

The modified olefin polymer is a polymer obtained by graft-polymerizing an olefin polymer with at least one kind of compound selected from the group consisting of an unsaturated carboxylic acid and derivatives thereof, and examples thereof include:
(1) a modified olefin polymer obtained by graft-polymerizing a homopolymer of an olefin with at least one kind of a compound selected from the group consisting of an unsaturated carboxylic acid and derivatives thereof,
(2) a modified olefin polymer obtained by graft-polymerizing a copolymer, obtained by copolymerizing at least two kinds of olefins, with at least one kind of compound selected from the group consisting of an unsaturated carboxylic acid and derivatives thereof, and
(3) a modified olefin polymer obtained by graft-polymerizing a block copolymer, obtained by homopolymerizing an olefin and copolymerizing with at least two kinds of olefins, with at least one kind of compound selected from the group consisting of an unsaturated carboxylic acid and derivatives thereof. Also, the modified olefin polymer includes:
(4) a modified olefin polymer obtained by copolymerizing at least one kind of olefin with at least one kind of compound selected from the group consisting of an unsaturated carboxylic acid and derivatives thereof.

Examples of the unsaturated carboxylic acid include maleic acid, fumaric acid, itaconic acid, acrylic acid and methacrylic acid.

Examples of the derivative of the unsaturated carboxylic acid include an acid anhydride, an ester compound, an amide compound, an imide compound and a metal salt of the unsaturated carboxylic acid. Specific examples thereof include maleic anhydride, itaconic anhydride, methyl acrylate; ethyl acrylate, butyl acrylate, glycidyl acrylate, methyl methacrylate, ethyl methacrylate, butyl methacrylate, glycidyl methacrylate, 2-hydroxyethyl methacrylate, maleic acid monoethyl ester, maleic acid diethyl ester, fumaric acid monomethyl ester, fumaric acid dimethyl ester, acrylamide, methacrylamide, maleic acid monoamide, maleic acid diamide, fumaric acid monoamide, maleimide, N-butylmaleimide and sodium methacrylate.

Also, the unsaturated carboxylic acid may be an unsaturated carboxylic acid produced by a dehydration reaction of a compound such as citric acid or malic acid, which is converted into an unsaturated carboxylic acid through a dehydration reaction. Since an unsaturated carboxylic acid is produced by a dehydration reaction when such a compound is graft-polymerized with an olefin polymer, the unsaturated carboxylic acid thus produced is graft-polymerized with the olefin polymer.

At least one kind of a compound selected from the group consisting of an unsaturated carboxylic acid and derivatives thereof is preferably glycidyl acrylate, glycidyl methacrylate, maleic anhydride or 2-hydroxyethyl methacrylate.

A modified olefin polymer may be used alone, but is usually used in combination with an olefin polymer.

The crystalline thermoplastic polymer composition of the present invention may contain an elastomer. Examples of the elastomer include an ethylene-α-olefin random copolymer, an ethylene-α-olefin-non-conjugated polyene random copolymer and a hydrogenated block copolymer, and these elastomers are used alone, or two or more kinds of them are used in combination.

The crystalline thermoplastic polymer composition of the present invention may contain various additives for any purpose. Examples of the additives include additives for modification such as dispersants, lubricants, plasticizers, flame retardants, antioxidants, antistatic agents, photostabilizers and ultraviolet absorbers; colorants such as pigments and dyes; granular fillers such as carbon black, talc, calcium carbonate, mica and clay; short fibrous fillers such as wollastonite; and whiskers such as potassium titanate.

The crystalline thermoplastic polymer composition of the present invention can be produced, for example, by mixing a crystalline thermoplastic polymer and a crystal nucleating agent coated aluminum hydroxide at a temperature which is lower than the melting point of the crystalline thermoplastic polymer composition, followed by melt-kneading the resulting mixture.

It is preferred that the crystalline thermoplastic polymer and the crystal nucleating agent coated aluminum hydroxide are uniformly mixed. These components may be uniformly mixed using, for example, a Henschel mixer, a ribbon blender or a blender. In the case of melt-kneading, a Banbury mixer, a plasto mill, a Brabender plasto-graph, a single screw extruder or a twin screw extruder is used. In the case of containing additives, the additives may be preliminarily added to the crystalline thermoplastic polymer, or may be added to the crystal nucleating agent coated aluminum hydroxide, or may be added in the case of mixing the crystalline thermoplastic polymer and the crystal nucleating agent coated aluminum hydroxide.

### EXAMPLES

Specific Examples of the present invention will now be described, but the present invention is not limited to the following Examples. The methods for measurement of the physical properties in the Examples are as follows.

### (1) Flexural Modulus (FM, Unit: MPa)

The flexural modulus was measured by a method defined in JIS-K-7171. Using a test piece having a thickness of 4 mm and a span length of 64 mm, the measurement was conducted at a loading rate of 2 mm/min at 23° C.

### (2) Flexural Strength (FS, Unit: MPa)

The flexural strength of elasticity was measured by a method defined in JIS-K-7171. Using a test piece having a thickness of 4 mm and a span length of 64 mm, the measurement was conducted at a loading rate of 2 mm/min at 23° C.

### (3) Crystallization Temperature (Tc, Unit: ° C.)

Using a differential scanning calorimeter (DSC) (“DSC-60”, manufactured by Shimadzu Corporation), the crystallization temperature was measured by a method defined in JIS-K-7121. A measuring sample was made by cutting a test piece obtained by injection molding of a polymer composition. The top of a crystallization peak obtained in the case of cooling at a rate of 5° C./min. from the molten state at a nitrogen flow rate of 50 ml/min was measured as the crystallization temperature.

### (4) BET Specific Surface Area

A BET specific surface area was measured by a nitrogen adsorption method in accordance with a method defined in JIS-Z-8830.

### (5) Aggregate Particle Diameter of Anisotropic Shaped Aluminum Hydroxide Particles

Using a laser scattering type particle size distribution meter (“Microtrac HRA”, manufactured by Leeds & Northrap Corp.), a particle diameter distribution curve was measured and the aggregate particle diameter was determined as a 50 wt % equivalent particle diameter (D₅₀).

(6) Length (a) in a-Axis Direction, Length (b) in b-Axis

### Direction and Aspect Ratio of Needle Shaped Aluminum Hydroxide Particles

With respect to each particle among 10 needle shaped aluminum hydroxide particles selected from an electron micrograph, a length (a) in an a-axis direction where the length is a maximum and a length (b) in a b-axis direction where the length is a minimum were respectively determined, the aspect ratio was calculated, and then the arithmetical mean thereof was calculated as the length in the a-axis direction, the length in the b-axis direction and the aspect ratio.

### Example 1

### Production of Needle Shaped Aluminum Hydroxide Particles

100 parts by mass of gibbsite-type aluminum hydroxide particles having a BET specific surface area of 25 m²/g and a aggregate particle diameter of 0.5 μm, 219 parts by mass of magnesium acetate tetrahydrate (CH₃COOMg.4H₂O) and 2,100 parts by mass of pure water were mixed and, after adjusting the hydrogen ion concentration to pH 5.0 by adding acetic acid (CH₃COOH) to the resulting slurry, the slurry was charged in an autoclave, and heated from room temperature (about 20° C.) to 200° C. at a heating rate of 100° C./hour and maintained at 200° C. for 4 hours. After cooling, the solid matter was separated by a filtration and washed with water until the filtrate exhibits electric conductivity of 100 μS/cm or less, and then pure water was added to obtain a slurry having a solid content of 5% by mass. After removing coarse granules by a SUS sieve having a sieve opening size of 45 μm, the resulting slurry was spray-dried at an outlet temperature of 120° C. using a spray dryer (Mobile Minor Model, manufactured by Niro Japan Co. Ltd.) and then ground using a rotor speed mill (“P-14”, manufactured by Fritsch Co.) to obtain a needle shaped aluminum hydroxide particles. The resulting needle shaped aluminum hydroxide showed a boehmite crystal form and also had a BET specific surface area of 66 m²/g, a length (a) in an a-axis direction of 2,520 nm, a length (b) in a b-axis direction of 102 nm, and an aspect ratio of 27.

### (Production of Crystal Nucleating Agent Coated Aluminum Hydroxide)

500 parts by mass of pure water was heated to 95° C. and then 2.8 parts by mass of benzoic acid (crystal nucleating agent) and 2.8 parts by mass of sodium benzoate (crystal nucleating agent) were added and dissolved to obtain an aqueous solution. The resulting aqueous solution had a hydrogen ion concentration of pH 4.

The aqueous solution obtained above was maintained at a temperature of 90 to 95° C. and a mixture of 100 parts by mass of the needle shaped aluminum hydroxide particles obtained above and 900 parts by mass of pure water was added at a rate of 40 parts by mass/min while stirring. After that, stirring was continued for an additional 2 hours.

Then, the resulting slurry was spray-dried at an outlet temperature of 120° C. using a spray dryer (Mobile Minor Model, manufactured by Niro Japan Co. Ltd.) and then ground using a rotor speed mill (“P-14”, manufactured by Fritsch Co.) to obtain a crystal nucleating agent coated aluminum hydroxide. The coated amount of the crystal nucleating agent of the resulting crystal nucleating agent coated aluminum hydroxide was determined from the carbon content measured by a carbon content measuring apparatus (“SUMIGRAPH NCH-21”, manufactured by Sumika Chemical Analysis Service, Ltd.). As a result, it was 9.3 parts by mass based on 100 parts by mass of the crystal nucleating agent coated aluminum hydroxide. Also, the crystal nucleating agent coated aluminum hydroxide had a BET specific surface area of 26 m²/g and an aggregate particle diameter (D₅₀) of 0.65 μm.

### (Production of Crystalline Thermoplastic Polymer Composition)

100 parts by mass of a propylene block copolymer, 2 parts by mass of the crystal nucleating agent coated aluminum hydroxide obtained above (amount of crystal nucleating agent: 0.19 parts by mass) and 0.2 parts by mass of Irganox 1010 (additive, manufactured by Ciba Specialty Chemicals Inc.) were mixed and the resulting mixture was melt-kneaded for 10 minutes under the conditions of a preset temperature of 180° C. and a rotation speed of 60 rpm using a laboplasto mill (“Laboplasto Mill 100M”, manufactured by TOYO SEIKI Co., Ltd.) to obtain a polymer composition. The resulting polymer composition was injection-molded using an injection molding machine (“Model IMC-1658”, manufactured by Imoto Seisakusho Co., Ltd.) to obtain a test piece. The resulting test piece was evaluated. The results are shown in Table 1.

The intrinsic viscosity of the propylene block copolymer used was 1.52 dL/g, the content of a propylene-ethylene block copolymer moiety was 16% by mass, and the intrinsic viscosity of the propylene homopolymer moiety was 1.05 dL/g. The intrinsic viscosity and the content of the propylene-ethylene block copolymer moiety were measured by methods described in the Examples of Patent Document 4 (Japanese Unexamined Patent Publication (Kokai) No. 2006-83251).

### Comparative Example 1

### Production of Crystalline Thermoplastic Polymer Composition

In the same manner as in Example 1, except that the amount of the crystal nucleating agent coated aluminum hydroxide used in Example 1 was replaced by 0.2 parts by mass (amount of crystal nucleating agent: 0.02 parts by mass), the operation was conducted to obtain a polymer composition, and then a test piece was obtained. The resulting test piece was evaluated. The results are shown in Table 1.

### Comparative Example 2

### Production of Crystalline Thermoplastic Polymer Composition

In the same manner as in Example 1, except that 2 parts by mass of the needle shaped aluminum hydroxide obtained in Example 1 was used in place of the crystal nucleating agent coated aluminum hydroxide used in Example 1, the operation was conducted to obtain a polymer composition, and then a test piece was obtained. The resulting test piece was evaluated. The results are shown in Table 1.

### Comparative Example 3

### Production of Crystalline Thermoplastic Polymer Composition

In the same manner as in Example 1, except that 1.8 parts by mass of the needle shaped aluminum hydroxide obtained in Example 1 and 0.2 parts by mass of sodium benzoate were used in place of the crystal nucleating agent coated aluminum hydroxide used in Example 1, the operation was conducted to obtain a polymer composition, and then a test piece was obtained. The resulting test piece was evaluated. The results are shown in Table 1.

### Comparative Example 4

### Production of Crystalline Thermoplastic Polymer Composition

In the same manner as in Example 1, except that 0.2 parts by mass of sodium benzoate was used in place of the crystal nucleating agent coated aluminum hydroxide used in Example 1, the operation was conducted to obtain a polymer composition, and then a test piece was obtained. The resulting test piece was evaluated. The results are shown in Table 1.

### Comparative Example 5

In the same manner as in Example 1, except that the crystal nucleating agent coated aluminum hydroxide used in Example 1 was not used, the operation was conducted to obtain a test piece. The resulting test piece was evaluated. The results are shown in Table 1.

### Example 2

### Production of Plate Shaped Aluminum Hydroxide

7 parts by mass of a boehmite-type aluminum hydroxide (“CATAPAL D” manufactured by CONDEA Co., BET specific surface area: 241 m²/g, aggregate particle size: 52 μm) was mixed with 93 parts by mass of deionized water and the resulting mixture was subjected to a dispersion treatment using a continuous beads mill to obtain a slurry. To 149 parts by mass of the resulting slurry, 2,850 parts by mass of a gibbsite-type aluminum hydroxide (“C-301” manufactured by Sumitomo Chemical Co., Ltd., BET specific surface area: 6 m²/g, aggregate particle size: 1.4 μm), 180 parts by mass of acetic acid and 18,000 parts by mass of pure water were added, followed by stirring. The slurry was charged in an autoclave, and heated from room temperature (about 20° C.) to 180° C. at a heating rate of 100° C./hour and maintained at 180° C. for 4 hours. After cooling, the solid matter was separated, washed with water and then dried to obtain a plate shaped aluminum hydroxide. The resulting plate shaped aluminum hydroxide showed a boehmite crystal form and also had a BET specific surface area of 53 m²/g. From an electron micrograph of the resulting plate shaped aluminum hydroxide, the average length (a) in the surface direction (a-axis) was determined. As a result, it was 99 nm. The average length (b) in the thickness direction (b-axis) was 18 nm and the aspect ratio (a/b) thereof was 5.

### (Production of Crystal Nucleating Agent Coated Aluminum Hydroxide)

In the same manner as in Example 1, except that 100 parts by mass of the plate shaped aluminum hydroxide obtained above was used in place of the needle shaped aluminum hydroxide obtained in Example 1, the operation was conducted to obtain a crystal nucleating agent coated aluminum hydroxide. The coated amount of the crystal nucleating agent of the resulting crystal nucleating agent coated aluminum hydroxide was 6.1 parts by mass based on 100 parts by mass of the crystal nucleating agent coated aluminum hydroxide. Also, the crystal nucleating agent coated aluminum hydroxide had a BET specific surface area of 44 m²/g and an aggregate particle diameter (D₅₀) of 0.34 μm.

### (Production of Crystalline Thermoplastic Polymer Composition)

In the same manner as in Example 1, except that 2 parts by mass of the plate shaped aluminum hydroxide obtained in Example 2 (amount of crystal nucleating agent: 0.12 parts by mass) was used in place of the crystal nucleating agent coated aluminum hydroxide used in Example 1, the operation was conducted to obtain a polymer composition, and then a test piece was obtained. The resulting test piece was evaluated. The results are shown in Table 1.

TABLE 1

| | Ex. 1 | C. Ex. 1 | C. Ex. 2 | C. Ex. 3 | C. Ex. 4 | C. Ex. 5 | Ex. 2 |
|---|---|---|---|---|---|---|---|
| Shape | Needle | Needle | Needle | Needle | — | — | Plate |
| FM (Mpa) | 1,536 | 1,112 | 1,210 | 1,357 | 1,158 | 1,092 | 1,357 |
| FS (Mpa) | 42 | 35 | 36 | 39 | 36 | 35 | 40 |
| Tc (° C.) | 134.6 | 126.9 | 122.5 | 130.6 | 125.6 | 119.6 | 133.1 |
| Amount of | 2 | 0.2 | 2 | 1.8 | — | — | 2 |
| aluminum | | | | | | | |
| hydroxide | | | | | | | |
| (Parts by | | | | | | | |
| mass) | | | | | | | |
| Amount of | 0.19 | 0.02 | — | 0.20 | 0.20 | — | 0.12 |
| crystal | | | | | | | |
| nucleating | | | | | | | |
| agent | | | | | | | |
| (Parts by | | | | | | | |
| mass) | | | | | | | |

### Example 3

### Production of Crystal Nucleating Agent Coated Aluminum Hydroxide

An aqueous solution prepared by mixing 400 parts by mass of pure water and 200 parts by mass of ethanol was heated to 95° C. and then 8 parts by mass of 2-naphthoic acid (crystal nucleating agent) was added and dissolved to obtain an aqueous solution.

The aqueous solution obtained above was maintained at a temperature of 90 to 95° C. and a mixture of 72 parts by mass of the needle shaped aluminum hydroxide obtained in Example 1 and 1,000 parts by mass of pure water was added at a rate of 100 parts by mass/min while stirring. After the addition, stirring was continued for an additional 2 hours. After stirring, the slurry was naturally cooled to room temperature and dried in an oven at 120° C. for 8 hours to obtain a white solid. Then, the resulting white solid was ground using a rotor speed mill (“P-14”, manufactured by Fritsch Co.) to obtain a crystal nucleating agent coated aluminum hydroxide particles. The coated amount of the crystal nucleating agent of the resulting crystal nucleating agent coated aluminum hydroxide was 9.6 parts by mass based on 100 parts by mass of the crystal nucleating agent coated aluminum hydroxide. Also, the crystal nucleating agent coated aluminum hydroxide had a BET specific surface area of 42 m²/g and an aggregate particle diameter (D₅₀) of 0.83 μm.

### (Production of Crystalline Thermoplastic Polymer Composition)

100 parts by mass of a propylene block copolymer, 2 parts by mass of the crystal nucleating agent coated aluminum hydroxide obtained above (amount of crystal nucleating agent: 0.19 parts by mass), 0.05 parts by mass of calcium stearate (manufactured by NOF Corporation), 0.1 parts by mass of Irganox 1010 (manufactured by Ciba Specialty Chemicals Inc.) and 0.1 parts by mass of Irgafos 168 (manufactured by Ciba Specialty Chemicals Inc.) were uniformly mixed and the resulting mixture was melt-kneaded under the conditions of a temperature of 220° C. and a screw rotation speed of 50 rpm using a twin screw extruder (2D30W2, manufactured by TOYO SEIKI Co., Ltd.) to obtain a polymer composition in the form of pellets. The resulting polymer composition was injection-molded using an injection molding machine (“Model IMC-1658”, manufactured by Imoto Seisakusho Co., Ltd.) to obtain a test piece. The resulting test piece was evaluated. The results are shown in Table 2.

The intrinsic viscosity of the propylene block copolymer used was 1.52 dL/g, the content of the propylene-ethylene block copolymer moiety was 19% by mass, and the intrinsic viscosity of a propylene homopolymer moiety was 1.05 dL/g.

### Example 4

### Production of Crystal Nucleating Agent Coated Aluminum Hydroxide

400 parts by mass of pure water was heated to 95° C. and then 8 parts by mass of benzoic acid (crystal nucleating agent) was added and dissolved to obtain an aqueous solution.

The aqueous solution obtained above was maintained at a temperature of 90 to 95° C. and a mixture of 72 parts by mass of the needle shaped aluminum hydroxide obtained in Example 1 and 1,000 parts by mass of pure water was added at a rate of 100 parts by mass/min while stirring. After the completion of the addition, stirring was continued for additional 2 hours. After stirring, the slurry was naturally cooled to room temperature and dried in an oven at 120° C. for 8 hours to obtain a white solid. The resulting white solid was ground using a rotor speed mill (“P-14”, manufactured by Fritsch Co.) to obtain a crystal nucleating agent coated aluminum hydroxide. The coated amount of the crystal nucleating agent of the resulting crystal nucleating agent coated aluminum hydroxide was 7.3 parts by mass based on 100 parts by mass of the crystal nucleating agent coated aluminum hydroxide. Also, the crystal nucleating agent coated aluminum hydroxide had a BET specific surface area of 30 m²/g and an aggregate particle diameter (D₅₀) of 0.29 μm.

### (Production of Crystalline Thermoplastic Polymer Composition)

In the same manner as in Example 4, except that 2 parts by mass of the needle shaped aluminum hydroxide obtained in Example 5 (amount of crystal nucleating agent: 0.15 parts by mass) was used in place of the crystal nucleating agent coated aluminum hydroxide used in Example 4, the operation was conducted to obtain a polymer composition, and then a test piece was obtained. The resulting test piece was evaluated. The results are shown in Table 2.

### Comparative Example 6

### Production of Crystal Nucleating Agent Coated Aluminum Hydroxide

In the same manner as in Example 3, except that a spherical aluminum oxide (Aluminum Oxide C, manufactured by Nippon Aerosil Co., Ltd.) was used in place of the needle shaped aluminum hydroxide in Example 3, the operation was conducted to obtain a crystal nucleating agent coated aluminum hydroxide. The coated amount of the crystal nucleating agent of the resulting crystal nucleating agent coated aluminum oxide was 9.9 parts by mass based on 100 parts by mass of the crystal nucleating agent coated aluminum oxide. Also, the crystal nucleating agent coated aluminum oxide had a BET specific surface area of 123 m²/g and an aggregate particle diameter (D₅₀) of 8.7 μm.

### (Production of Crystalline Thermoplastic Polymer Composition)

In the same manner as in Example 3, except that 2 parts by mass of the crystal nucleating agent coated aluminum oxide obtained in Comparative Example 6 (amount of crystal nucleating agent: 0.20 parts by mass) was used in place of the crystal nucleating agent coated aluminum hydroxide used in Example 4, the operation was conducted to obtain a polymer composition, and then a test piece was obtained. The resulting test piece was evaluated. The results are shown in Table 2.

### Comparative Example 7

### Production of Crystal Nucleating Agent Coated Aluminum Hydroxide

In the same manner as in Example 4, except that a spherical aluminum oxide (Aluminum Oxide C, manufactured by Nippon Aerosil Co., Ltd.) was used in place of the needle shaped aluminum hydroxide in Example 4, the operation was conducted to obtain a crystal nucleating agent coated aluminum hydroxide. The coated amount of the crystal nucleating agent of the resulting crystal nucleating agent coated aluminum oxide was 10 parts by mass based on 100 parts by mass of the crystal nucleating agent coated aluminum oxide. Also, the crystal nucleating agent coated aluminum oxide had a BET specific surface area of 119 m²/g and an aggregate particle diameter (D₅₀) of 8.5 μm.

### (Production of Crystalline Thermoplastic Polymer Composition)

In the same manner as in Example 4, except that 2 parts by mass of the crystal nucleating agent coated aluminum oxide obtained in Comparative Example 6 (amount of crystal nucleating agent: 0.20 parts by mass) was used in place of the crystal nucleating agent coated aluminum hydroxide used in Example 4, the operation was conducted to obtain a polymer composition, and then a test piece was obtained. The resulting test piece was evaluated. The results are shown in Table 2.

### Comparative Example 8

### Production of Crystalline Thermoplastic Polymer Composition

In the same manner as in Example 3, except that 2 parts by mass of the needle shaped aluminum hydroxide obtained in Example 1 was used in place of the crystal nucleating agent coated aluminum hydroxide used in Example 3, the operation was conducted to obtain a polymer composition, and then a test piece was obtained. The resulting test piece was evaluated. The results are shown in Table 2.

### Comparative Example 9

### Production of Crystalline Thermoplastic Polymer Composition

In the same manner as in Example 3, except that 2 parts by mass of a spherical aluminum oxide (Aluminum Oxide C, manufactured by Nippon Aerosil Co., Ltd.) was used in place of the crystal nucleating agent coated aluminum hydroxide used in Example 3, the operation was conducted to obtain a polymer composition, and then a test piece was obtained. The resulting test piece was evaluated. The results are shown in Table 2.

TABLE 2

| | Ex. 3 | Ex. 4 | C. Ex. 6 | C. Ex. 7 | C. Ex. 8 | C. Ex. 9 |
|---|---|---|---|---|---|---|
| Shape | Needle | Needle | Sphere | Sphere | Needle | Sphere |
| FM (Mpa) | 1,589 | 1,513 | 1,188 | 1,231 | 1,280 | 1,065 |
| FS (Mpa) | 39 | 39 | 35 | 36 | 34 | 33 |
| Tc (° C.) | 134.1 | 132.8 | 127.1 | 132.4 | 122.5 | 122.4 |
| Amount of aluminum | 2 | 2 | 2 | 2 | 2 | 2 |
| hydroxide | | | | | | |
| (Parts by mass) | | | | | | |
| Amount of crystal | 0.19 | 0.15 | 0.20 | 0.20 | — | — |
| nucleating agent | | | | | | |
| (Parts by mass) | | | | | | |

Comparing Examples 3 and 4 with Comparative Example 8, the flexural modulus is improved by 309 MPa and 233 MPa, respectively, by adding a crystal nucleating agent to an anisotropic shaped aluminum hydroxide. Comparing Comparative Examples 6 and 7 with Comparative Example 9, the flexural modulus is improved only by 123 MPa and 166 MPa, respectively, in the case of coating a spherical aluminum oxide crystal nucleating agent regardless of coating the same crystal nucleating agent as in Examples 3 and 4.

The major embodiments and the preferred embodiments of the present invention are listed below.
[1] A crystalline thermoplastic polymer composition comprising a crystalline thermoplastic polymer and a crystal nucleating agent coated aluminum hydroxide, the amount of the crystal nucleating agent coated aluminum hydroxide being from 1 to 20 parts by mass based on 100 parts by mass of the crystalline thermoplastic polymer, the crystal nucleating agent coated aluminum hydroxide comprising anisotropic shaped aluminum hydroxide particles and a crystal nucleating agent coated on the surface of the anisotropic shaped aluminum hydroxide particles, the crystal nucleating agent coated aluminum hydroxide having a BET specific surface area of 20 to 150 m²/g.
[2] The crystalline thermoplastic polymer composition according to [1], wherein a main crystal phase of the anisotropic shaped aluminum hydroxide particles is boehmite.
[3] The crystalline thermoplastic polymer composition according to [1] or [2], wherein the anisotropic shaped aluminum hydroxide particles are needle shaped aluminum hydroxide particles.
[4] The crystalline thermoplastic polymer composition according to any one of [1] to [3], wherein the crystal nucleating agent is an aromatic carboxylic acid compound represented by the formula (I):

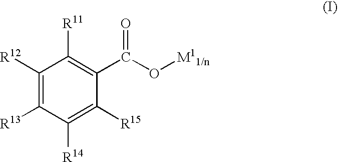

wherein R¹¹, R¹², R¹³, R¹⁴ and R¹⁵ each independently represents a hydrogen atom, an alkyl group having 1 to 4 carbon atoms, or a carboxyl group; M¹ represents a hydrogen atom or a mono- to trivalent metal atom; and n represents a valence of the hydrogen atom or the metal atom represented as M¹, or the formula (II):

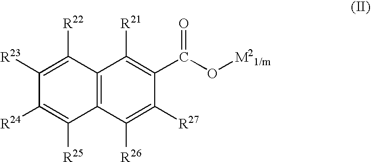

wherein R²¹, R²², R²³, R²⁴, R²⁵ , R²⁶ 7 and R²⁶ each independently represents a hydrogen atom, an alkyl group having 1 to 4 carbon atoms, or a carboxyl group; M² represents a hydrogen atom or a mono- to trivalent metal atom; and m represents a valence of the hydrogen atom or the metal atom represented as M².
[5] The crystalline thermoplastic polymer composition according to any one of [1] to [4], wherein a coated amount of the crystal nucleating agent is from 0.1 to 100 parts by mass based on 100 parts by mass of the anisotropic shaped aluminum hydroxide particles.
[6] The crystalline thermoplastic polymer composition according to any one of [1] to [5], wherein the crystalline thermoplastic polymer is an olefin polymer.
[7] A crystal nucleating agent coated aluminum hydroxide comprising anisotropic shaped aluminum hydroxide particles and a crystal nucleating agent coated on the surface of the anisotropic shaped aluminum hydroxide particles, the crystal nucleating agent coated aluminum hydroxide having a BET specific surface area of 20 to 150 m²/g.
[8] The crystal nucleating agent coated aluminum hydroxide according to [7], wherein a main crystal phase of the anisotropic shaped aluminum hydroxide particles is boehmite.
[9] The crystal nucleating agent coated aluminum hydroxide according to [7] or [8], wherein the anisotropic shaped aluminum hydroxide particles are needle shaped aluminum hydroxide particles.
[10] The crystal nucleating agent coated aluminum hydroxide according to any one of [7] to [9], wherein the crystal nucleating agent is an aromatic carboxylic acid compound represented by the above formula (I) or (II).

This application was filed claiming Paris Convention priority of Japanese Patent Application No. 2006-349249, the entire content of which is herein incorporated by reference.

What is claimed is:

1. A crystalline thermoplastic polymer composition comprising a crystalline thermoplastic polymer and a crystal nucleating agent coated aluminum hydroxide, the amount of the crystal nucleating agent coated aluminum hydroxide being from 1 to 20 parts by mass based on 100 parts by mass of the crystalline thermoplastic polymer, the crystal nucleating agent coated aluminum hydroxide comprising anisotropic shaped aluminum hydroxide particles and a crystal nucleating agent coated on the surface of the anisotropic shaped aluminum hydroxide particles, the crystal nucleating agent coated aluminum hydroxide having a BET specific surface area of 20 to 150 m²/g.

2. The crystalline thermoplastic polymer composition according to claim 1, wherein a main crystal phase of the anisotropic shaped aluminum hydroxide particles is boehmite.

3. The crystalline thermoplastic polymer composition according to claim 1 or 2, wherein the anisotropic shaped aluminum hydroxide particles are needle shaped aluminum hydroxide particles.

4. The crystalline thermoplastic polymer composition according to any one of claims 1 to 2, wherein the crystal nucleating agent is an aromatic carboxylic acid compound represented by the formula (I): 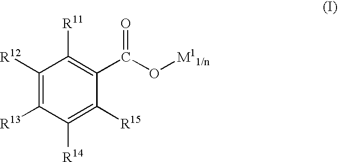
wherein R¹¹, R¹², R¹³, R¹⁴ and R¹⁵ each independently represents a hydrogen atom, an alkyl group having 1 to 4 carbon atoms, or a carboxyl group; M¹ represents a hydrogen atom or a mono- to trivalent metal atom; and n represents a valence of the hydrogen atom or the metal atom represented as M¹, or the formula (II): 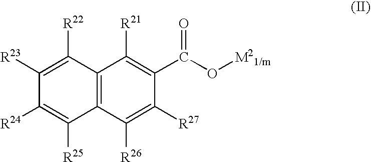
wherein R²¹, R²², R²³, R²⁴, R²⁵, R²⁶ and R²⁷ each independently represents a hydrogen atom, an alkyl group having 1 to 4 carbon atoms, or a carboxyl group; M² represents a hydrogen atom or a mono- to trivalent metal atom; and m represents a valence of the hydrogen atom or the metal atom represented as M².

5. The crystalline thermoplastic polymer composition according to any one of claims 1 to 2, wherein a coated amount of the crystal nucleating agent is from 0.1 to 100 parts by mass based on 100 parts by mass of the anisotropic shaped aluminum hydroxide particles.

6. The crystalline thermoplastic polymer composition according to any one of claims 1 to 2, wherein the crystalline thermoplastic polymer is an olefin polymer.

7. A crystal nucleating agent coated aluminum hydroxide comprising anisotropic shaped aluminum hydroxide particles and a crystal nucleating agent coated on the surface of the anisotropic shaped aluminum hydroxide particles, the crystal nucleating agent coated aluminum hydroxide having a BET specific surface area of 20 to 150 m²/g.

8. The crystal nucleating agent coated aluminum hydroxide according to claim 7, wherein a main crystal phase of the anisotropic shaped aluminum hydroxide particles is boehmite.

9. The crystal nucleating agent coated aluminum hydroxide according to claim 7 or 8, wherein the anisotropic shaped aluminum hydroxide particles are needle shaped aluminum hydroxide particles.

10. The crystal nucleating agent coated aluminum hydroxide according to any one of claims 7 to 8, wherein the crystal nucleating agent is an aromatic carboxylic acid compound represented by the above formula (I) or (II).
